(19) United States
(12) Patent Application Publication
(10) Pub. No.: US 2014/0073305 A1
(43) Pub. Date: Mar. 13, 2014

(54) PREEMPTIVE HARDWARE ACTIVATION

(71) Applicant: Benjamin Poulain, Cupertino, CA (US)

(72) Inventor: Benjamin Poulain, Cupertino, CA (US)

(73) Assignee: APPLE INC., Cupertino, CA (US)

(21) Appl. No.: 13/610,756

(22) Filed: Sep. 11, 2012

(51) Int. Cl. H04W 4/02

(52) U.S. Cl. 455/418

(57) ABSTRACT

Implementations are disclosed for activating hardware on a device preemptively based on whether a service associated with the hardware will be required or likely be used by an application, or if the application's access to the service is granted by a user of the application. The disclosed implementations provide a perceived improvement of performance by applications supported by slow starting hardware.

### TECHNICAL FIELD

This disclosure relates generally to activating hardware on a mobile device.

### BACKGROUND

Modern mobile devices include hardware that is activated to provide services to applications running on a processor of the mobile device. An example service is a location service, which provides the current location of the mobile device to applications. The location service receives location information from hardware on the mobile device, including Global Positioning System (GPS) or wireless network (e.g., Wi-Fi) integrated circuit chips. These chips consume a lot of power and therefore are often powered down when not in use. When location services are requested by an application, there is a delay in providing location information to the application while the hardware (e.g., a GPS receiver or wireless transciever chip) is starting up. This delay can be perceived by a user of the application, and can diminish the user's experience with the application.

### SUMMARY

Implementations are disclosed for activating hardware on a device preemptively based on whether a service associated with the hardware will be required or likely be used by an application, or if the application's access to the service is granted by a user of the application. The disclosed implementations provide a perceived improvement of performance by applications supported by slow starting hardware.

Particular implementations disclosed herein provide one or more of the following advantages. Activating hardware associated with a service preemptively provides a perceived reduction in delay by a user of an application using the service.

The details of the disclosed implementations are set forth in the accompanying drawings and the description below. Other features, aspects, and advantages of calibrating sensor measurements on mobile devices will become apparent from the description, the drawings, and the claims.

### BRIEF DESCRIPTION OF THE DRAWINGS

FIG. 1 illustrates an exemplary user interface for a mobile device presenting a dialog for granting or denying services.

FIGS. 2A and 2B are flow diagrams illustrating an exemplary process of preemptively activating hardware on a device.

FIG. 3 is a flow diagram of another exemplary process of preemptively activating hardware on a device.

FIG. 4 is a block diagram of an exemplary hardware architecture for implementing the system and processes referenced in FIGS. 1-3.

### DETAILED DESCRIPTION

### Exemplary User Interface

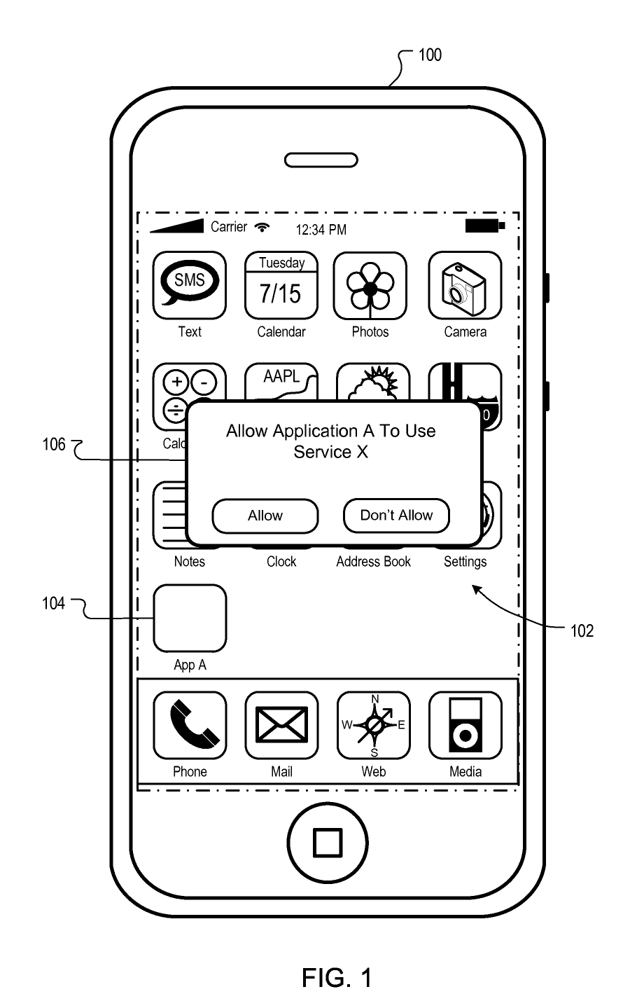

FIG. 1 illustrates an exemplary user interface for a mobile device presenting a dialog for granting or denying services. In some implementations, mobile device 100 can include display 102 for presenting icons representing applications available to a user of device 100. One or more of these applications can require the use of a service offered by an operating system running on device 100. For example, “Service X” can be a location service that provides the geographic location of device 100 to applications that request location service. The location service can receive geographic coordinates for device 100 from a variety of positioning technologies available to device 100, including Global Navigation Satellite System (GNSS), Wi-Fi (e.g., 3G, 4G) and cellular network positioning technologies.

Other services can include but are not limited to wireless services, video services and any other service that uses slow starting hardware that can be activated before the service can be provided. For example, for applications using wireless services (e.g., 3G, 4G), a wireless transceiver chip can be activated preemptively to reduce a perceived delay of wireless services. In another example, a digital signal processor (DSP) chip can be activated preemptively to reduce a perceived delay of video services.

Due to privacy concerns, device 100 may provide access dialog 106 on display 102 that allows the user to allow an application to use the service. In the example shown, the user has selected icon 104 to open “Application A” on device 100. Application A requested Service X from the operating system. Access dialog 106 requests the user to allow or disallow Service X for Application A. If the user selects the “Allow” button, Application A will have access to Service X. If the user selects the “Don't Allow” button, Application A will be denied access to Service X.

In some cases, there is hardware associated with Service X. For example, for location services a GPS receiver chip or wireless transceiver chip may have to be activated. Activation of hardware can include any process that is needed to bring hardware associated with the service to an operational state such that the service can be provided. For GPS activation, a GPS receiver chip can be started (e.g., turned on) or change its power state. For example, the GPS receiver can be moved from a low power state or “sleep” state to an operational state where satellite signals can be acquired and a position solution can be computed from the signals.

When the user selects the “Allow” button, the location data is available to the application immediately because the hardware was activated preemptively. For example, if Application A is a map application, the location of device 100 on a map display can be presented immediately without perceived delay. By activating hardware preemptively (before the service associated with the hardware is requested by the application), the delay perceived by the user can be reduced or eliminated, resulting in a more positive user experience with the application.

The example above is related to preemptive hardware activation when starting an application on device 100. Preemptive hardware activation, however, can be used in other use scenarios, including but not limited to presenting a dialog in a running application prior to providing a service that uses slow starting hardware (e.g., a map service) or a Web page requiring services from slow starting hardware. In the latter case, a Web page is similar to an instance in a particular runtime.

### Exemplary Processes

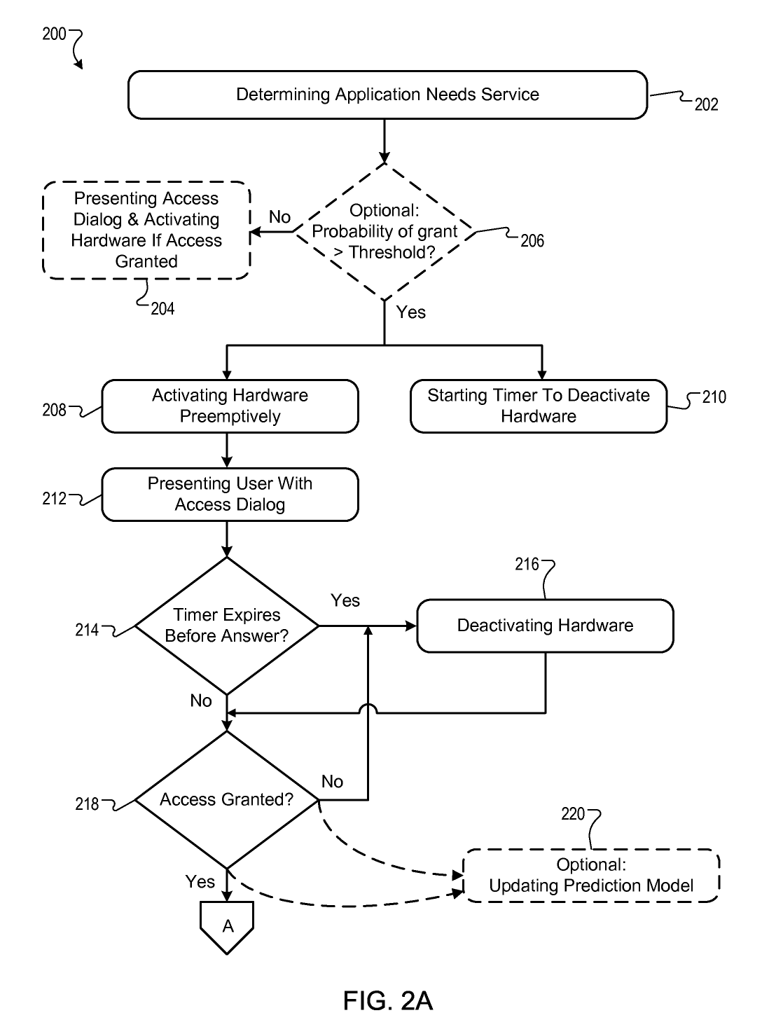

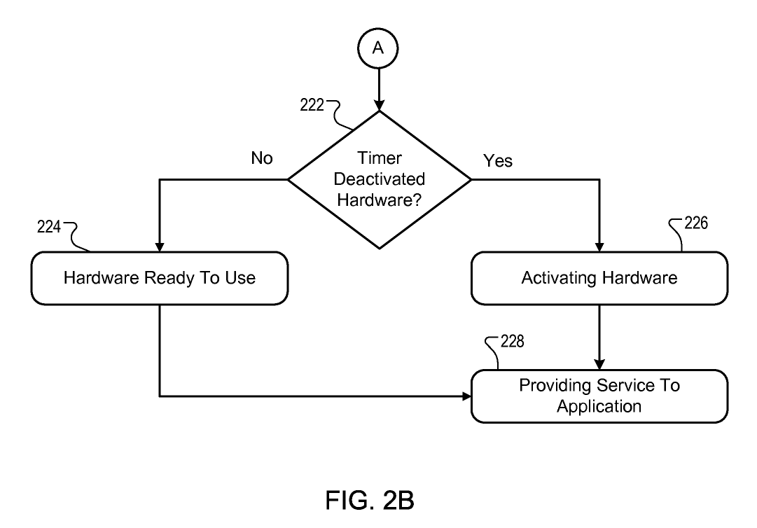

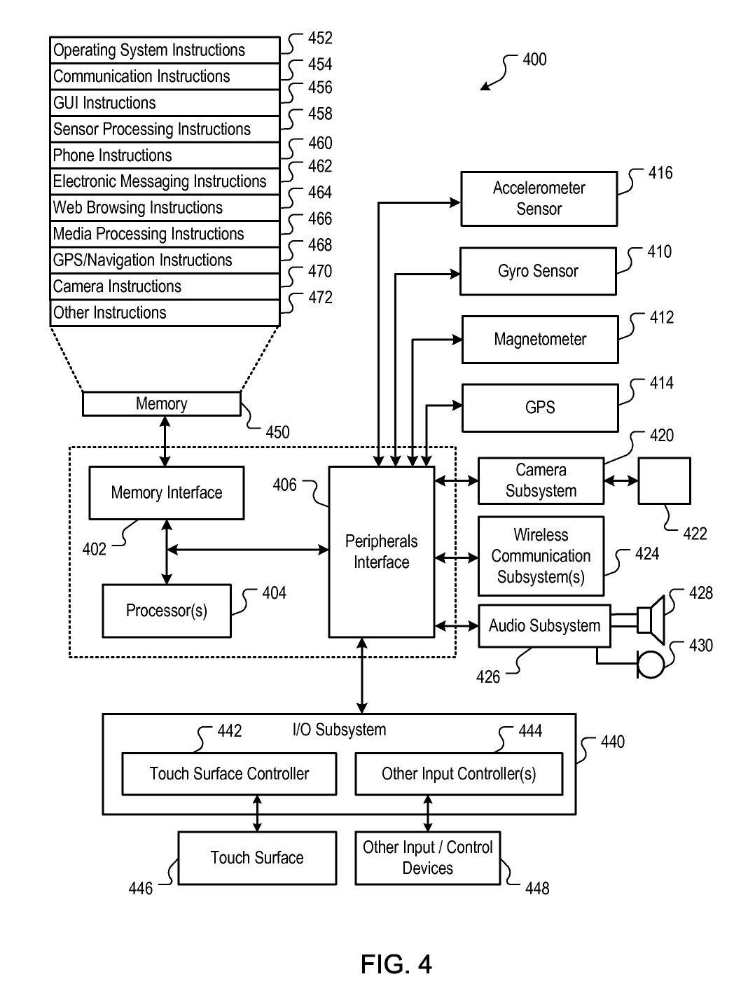

FIGS. 2A and 2B are a flow diagrams illustrating an exemplary process 200 of preemptively activating hardware on a device. Process 200 can be implemented on mobile device 100 of FIG. 1 using architecture 400 described in reference to FIG. 4.

In some implementations, process 200 can begin by determining that an application needs a service (202). In some implementations, an assumption can be made that the hardware will always be activated preemptively based on certain conditions. For example, process 200 can always activate hardware preemptively for third party applications that need the service.

Optionally, process 200 continues by determining the probability that the user will grant access to the service (206). The probability can be determined from a prediction model, as described below. If the probability is not greater than a threshold value, process 200 presents an access dialog to the user, and if the access is granted by the user, process 200 activates the hardware (204), as described in reference to FIG. 1.

If the probability that the user will grant access to the service is greater than a threshold value, process 200 activates the hardware preemptively (208) and starts a timer to deactivate the hardware (210). After starting activation of the hardware preemptively, process 200 presents an access dialog to the user (212).

If the timer expires before the user answers the dialog (214), process 200 deactivates the hardware (216). If the timer does not expire before the user answers the dialog and the user does not grant access before the timer expires (218), process 200 deactivates the hardware (216). Optionally, at step 218, the prediction model can be updated (220) regardless of the result of step 218, as described below.

Referring to FIG. 2B, if the user grants access and the timer deactivated the hardware in step 214 (222), process 200 activates the hardware (226) and provides the service to the application (228). If the timer did not deactivate the hardware, the hardware is ready to use (224) and process 200 provides the service to the application (228).

The prediction model described above can be based on the type of application or historical patterns of usage. For example, if the user has always allowed access to a service or has allowed access x percentage of the time (e.g., 80%), then the probability that access will be allowed by the user in the current instance is high. In some implementations, a count stored in memory or other storage device can be updated (e.g., incremented or decremented) each time a user allows or disallows access to a service for a given application, and the count can be used to determine the probability.

For another example, if the application is a map application invoked by the user, there is a high probability that the user will allow access to location services, since location determination is a primary function of a map application. By contrast, an application may only want the user's location for marketing purposes, such as to determine demographics of users who use the application or to target advertisements based on locality. With these types of applications, where the location of device 100 is not a primary function of the application, there is a low probability that the user will allow access to location services due to privacy concerns.

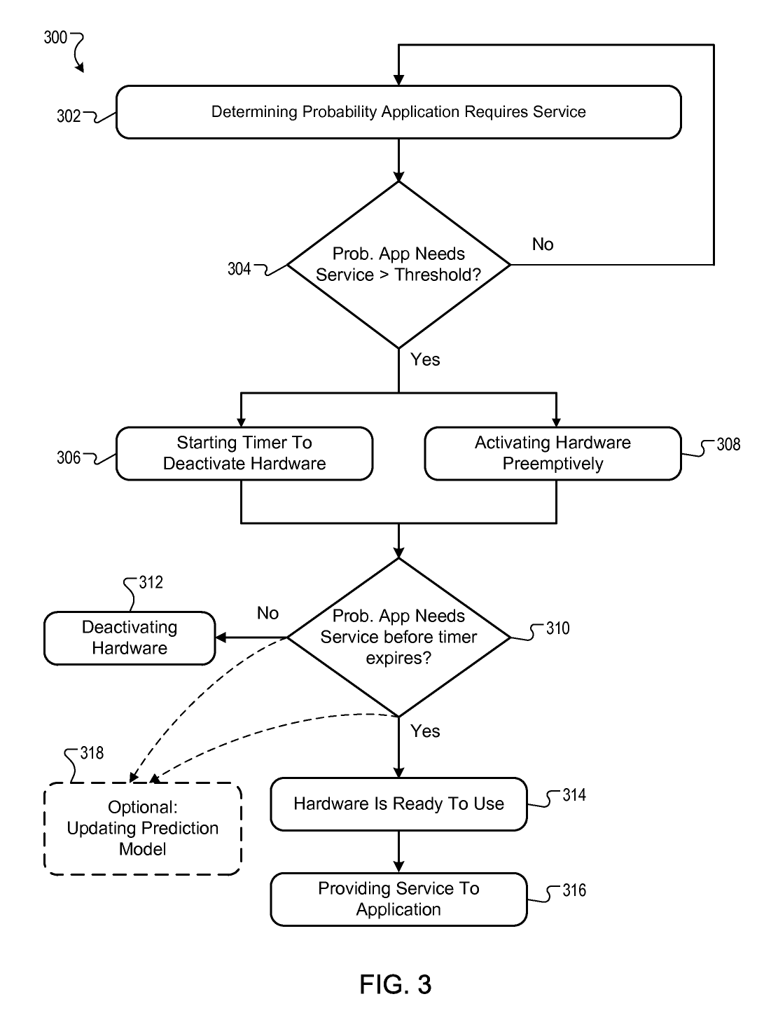

FIG. 3 is a flow diagram of another exemplary process 300 for preemptively activating hardware on a device. Process 300 can be implemented on mobile device 100 of FIG. 1 using architecture 400 described in reference to FIG. 4.

In some implementations, process 300 can be used in the case of dynamic programming languages (e.g., Web pages). Process 300 can also be used for applications that load dynamically a library that provides a service that uses slow starting hardware. If the application loads a library dynamically, there is a high probability the application will need the service soon. This information can be used to determine the probability used in step 304 described below.

Process 300 can also be used when an application instantiates one or more objects that relate to a service or a query for service availability. For example, if an application queries the operating system of a device to determine if the device is location aware, there is a at least a good probability that the application will request a location service in a subsequent step, such as requesting the start of location service hardware (e.g., a GPS receiver chip).

In some implementations, process 300 can begin by determining the probability an application needs a service (302). If the probability exceeds a predetermined threshold value (304), the hardware is activated preemptively (308) and a timer is started to deactivate the hardware (306). The probability can be determined from a prediction model based on metadata provided by the application or other information that can be used to make such determination. For example, metadata can be provided by the application to the operating system of device 100 according to an Application Programming Interface (API). The metadata can include entitlements or authorizations to access network resources or other operating system functions associated with the service. In some implementations that use dynamic programming languages (e.g., Web pages), determining the probability an application needs a service can include determining which data objects (e.g., JavaScript® objects) are being used by the application.

Process 300 continues by determining if application needs the service before the timer expires (310). If the application does not need the service before the timer expires, process 300 deactivates the hardware (312). If the application needs the service before the timer expires, the hardware is ready to use (314) and process 300 provides the service to the application (316). A step 310, process 300 optionally updates the prediction model (318).

### Exemplary Device Architecture

FIG. 4 is a block diagram of an exemplary hardware architecture 400 for implementing the user interface and processes referenced in FIGS. 1-3. Architecture 400 can include memory interface 402, one or more data processors, image processors and/or processors 404, and peripherals interface 406. Memory interface 402, processor(s) 404 and/or peripherals interface 406 can be separate components or can be integrated in one or more integrated circuits. The various components in the device, for example, can be coupled by one or more communication buses or signal lines.

Sensors, devices, and subsystems can be coupled to peripherals interface 406 to facilitate multiple functionalities. For example, angular rate sensor 410 (e.g., a MEMS gyro), magnetometer sensor 412 and location processor 414 (e.g., GPS receiver) can be connected to peripherals interface 406 to provide geo-positioning. Accelerometer 416 can also be connected to peripherals interface 406 to provide data that can be used to determine change of speed and direction of movement of the mobile device.

Camera subsystem 420 and an optical sensor 422, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 424, which can include radio frequency receivers and transmitters and/or optical (e.g., infrared) receivers and transmitters. The specific design and implementation of the communication subsystem 424 can depend on the communication network(s) over which a mobile device is intended to operate. For example, a mobile device can include communication subsystems 424 designed to operate over a GSM network, a GPRS network, an EDGE network, a Wi-Fi or Wi-Max network, and a Bluetooth network. In particular, the wireless communication subsystems 424 can include hosting protocols such that the mobile device can be configured as a base station for other wireless devices.

Audio subsystem 426 can be coupled to a speaker 428 and a microphone 440 to facilitate voice-enabled functions, such as voice recognition, voice replication, digital recording, and telephony functions.

I/O subsystem 440 can include touch surface controller 442 and/or other input controller(s) 444. Touch-screen controller 442 can be coupled to a touch surface 446 (e.g., display screen, pad). Touch surface 446 and touch surface controller 442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 446.

Other input controller(s) 444 can be coupled to other input/control devices 448, such as one or more buttons, rocker switches, thumb-wheel, infrared port, USB port, and/or a pointer device such as a stylus. The one or more buttons (not shown) can include an up/down button for volume control of speaker 428 and/or microphone 440.

In one implementation, a pressing of the button for a first duration may disengage a lock of the touch surface 446; and a pressing of the button for a second duration that is longer than the first duration may turn power to the device on or off. The user may be able to customize a functionality of one or more of the buttons. The touch surface 446 can be used to implement virtual or soft buttons and/or a keyboard.

In some implementations, the device can present recorded audio and/or video files, such as MP4, AAC, and MPEG files. In some implementations, the device can include the functionality of an MP4 player.

Memory interface 402 can be coupled to memory 450. Memory 450 can include high-speed random access memory and/or non-volatile memory, such as one or more magnetic disk storage devices, one or more optical storage devices, and/or flash memory (e.g., NAND, NOR). Memory 450 can store operating system 452, such as Darwin, RTXC, LINUX, UNIX, OS X, WINDOWS, or an embedded operating system such as VxWorks. Operating system 452 may include instructions for handling basic system services and for performing hardware dependent tasks. In some implementations, operating system 452 can include a kernel (e.g., UNIX kernel). Operating system 452 can implement all or some of the features and processes described in reference to FIGS. 1-3.

Memory 450 may also store communication instructions 454 to facilitate communicating with one or more additional devices, one or more computers or servers. Memory 450 may include graphical user interface instructions 456 to facilitate graphic user interface processing (e.g., the user interface shown in FIG. 1); sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GPS/Navigation instructions 468 to facilitate GPS and navigation-related processes and instructions; and camera instructions 470 to facilitate camera-related processes and functions. The memory 450 may also store other software instructions (not shown), such as security instructions, web video instructions to facilitate web video-related processes and functions, and/or web-shopping instructions to facilitate web shopping-related processes and functions. In some implementations, the media processing instructions 466 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 450. Memory 450 can include other instructions 472 for implementing applications on mobile device 100, such as applications that use services associated with hardware that can be activated preemptively, as described in reference to FIGS. 1-3.

Each of the above identified instructions and applications can correspond to a set of instructions for performing one or more functions described above. These instructions need not be implemented as separate software programs, procedures, or modules. Memory 450 can include additional instructions or fewer instructions. Furthermore, various functions of the mobile device may be implemented in hardware and/or in software, including in one or more signal processing and/or application specific integrated circuits.

The features described can be implemented in digital electronic circuitry or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. Alternatively or addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer can include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining that an application running on a device requires or is likely to use a service supported by hardware in the device; and
activating the hardware before the service is requested by the application;
starting a timer to deactivate the hardware;
determining that the application does not require or is unlikely to use the service before the timer expires; and
deactivating the hardware prior to the timer expiring.

2. The method of claim 1, where the device is a mobile device and the service is a location service.

3. The method of claim 1, further comprising:
presenting a dialog on a display of the device after starting the activating, the dialog providing an option for allowing or disallowing the application to access the service;
determining that access is allowed; and
allowing the application to access the service.

4. The method of claim 1, further comprising:
presenting a dialog on a display of the device after starting the activating, the dialog providing an option for allowing or disallowing the application to access the service;
determining that access is denied; and
deactivating the hardware.

5. The method of claim 1, further comprising:
presenting a dialog on a display of the device after starting the activating, the dialog providing an option for allowing or disallowing the application to access the service;
determining that the timer has expired without the option being exercised by a user of the device; and
deactivating the hardware.

6. The method of claim 1, where activating hardware includes starting the hardware or changing the power state of the hardware.

7. The method of claim 1, where the service is wireless services and the hardware is a wireless transceiver.

8. The method of claim 1, where the service includes video encoding or decoding and the hardware is a digital signal processor (DSP).

9. The method of claim 1, where determining that an application running on a device requires or is likely to use a service is based on metadata provided by the application.

10. The method of claim 1, where the application provides a webpage and determining that an application running on a device requires or is likely to use a service is based on software objects used by the webpage.

11. A system comprising:
one or more processors;
memory coupled to the one or more processors and configured for storing instructions, which, when executed by the one or more processors, causes the one or more processors to perform operations comprising:
determining that an application running on a device requires or is likely to use a service supported by hardware in the device; and
activating the hardware on the device before the service is requested by the application;
starting a timer to deactivate the hardware;
determining that the application does not require or is unlikely to use the service before the timer expires; and
deactivating the hardware prior to the timer expiring.

12. The system of claim 11, where the device is a mobile device and the service is a location service.

13. The system of claim 11, where the instructions, when executed by the one or more processors, causes the one or more processors to perform operations comprising:
presenting a dialog on a display of the device after starting the activating, the dialog providing an option for allowing or disallowing the application to access the service;
determining that access is allowed; and
allowing the application to access the service.

14. The system of claim 11, where the instructions, when executed by the one or more processors, causes the one or more processors to perform operations comprising:
presenting a dialog on a display of the device after starting the activating, the dialog providing an option for allowing or disallowing the application to access the service;
determining that access is denied; and
deactivating the hardware.

15. The system of claim 11, where the instructions, when executed by the one or more processors, causes the one or more processors to perform operations comprising:
presenting a dialog on a display of the device after starting the activating, the dialog providing an option for allowing or disallowing the application to access the service;
determining that the timer has expired without the option being exercised by a user of the device; and
deactivating the hardware.

16. The system of claim 11, where activating hardware includes starting the hardware or changing the power state of the hardware.

17. The system of claim 11, where the service is wireless services and the hardware is a wireless transceiver.

18. The system of claim 11, where the service includes video encoding or decoding and the hardware is a digital signal processor (DSP).

19. The system of claim 11, where determining that an application running on a device requires or is likely to use a service is based on metadata provided by the application.

20. The system of claim 11, where the application provides a webpage and determining that an application running on a device requires or is likely to use a service is based on data objects used by the webpage.

21. A method comprising:
determining a probability that an application running on a device is likely to use a service supported by hardware in or coupled to the device, where the probability is determined from a predictive model based on application type;
comparing the probability with a threshold value; and
activating the hardware before the service is requested by the application based on results of the comparing,
where the method is performed by one or more hardware processors.

22. The method of claim 21, where determining the probability further comprises:
determining that a primary function of the application is related to the service supported by the hardware.

23. The method of claim 21, where the prediction model is based at least in part on metadata provided by the application.

24. The method of claim 23, where the metadata includes entitlements or authorizations to access network resources or other operating system functions associated with the service.

25. The method of claim 23, where the metadata indicates software objects that are being used by the application.

26. The method of claim 21, where the device is a mobile device and the service is a location service.

27. The method of claim 21, further comprising:
presenting a dialog on a display of the device after starting the activating, the dialog providing an option for allowing or disallowing the application to access the service;
determining that access is allowed; and
allowing the application to access the service.

28. The method of claim 21, further comprising:
presenting a dialog on a display of the device after starting the activating, the dialog providing an option for allowing or disallowing the application to access the service;
determining that access is denied; and
deactivating the hardware.

29. The method of claim 21, further comprising:
presenting a dialog on a display of the device after starting the activating, the dialog providing an option for allowing or disallowing the application to access the service;
determining that the timer has expired without the option being exercised by a user of the device; and
deactivating the hardware.

30. The method of claim 21, where activating hardware includes starting the hardware or changing the power state of the hardware.

31. The method of claim 21, where the service is wireless services and the hardware is a wireless transceiver.

32. The method of claim 21, where the service includes video encoding or decoding and the hardware is a digital signal processor (DSP).

33. A method comprising:
determining a probability that an application running on a device is likely to use a service supported by hardware in or coupled to the device, where the probability is determined from a predictive model based on historical usage patterns for the application;
comparing the probability with a threshold value; and
activating the hardware before the service is requested by the application based on results of the comparing,
where the method is performed by one or more hardware processors.

34. The method of claim 33, where determining the probability further comprises:
determining a number of times the application has been accessed in the past.

35. The method of claim 34, where determining a number of times the application has been accessed in the past includes incrementing or decrementing a count each time the application is accessed.

36. The method of claim 34, determining a number of times the application has been accessed in the past includes incrementing or decrementing a count each time a user grants access to the application.

37. The method of claim 33, where the device is a mobile device and the service is a location service.

38. The method of claim 33, further comprising:
presenting a dialog on a display of the device after starting the activating, the dialog providing an option for allowing or disallowing the application to access the service;
determining that access is allowed; and
allowing the application to access the service.

39. The method of claim 33, further comprising:
presenting a dialog on a display of the device after starting the activating, the dialog providing an option for allowing or disallowing the application to access the service;
determining that access is denied; and
deactivating the hardware.

40. The method of claim 33, further comprising:
presenting a dialog on a display of the device after starting the activating, the dialog providing an option for allowing or disallowing the application to access the service;
determining that the timer has expired without the option being exercised by a user of the device; and
deactivating the hardware.

41. The method of claim 33, where activating hardware includes starting the hardware or changing the power state of the hardware.

42. The method of claim 33, where the service is wireless services and the hardware is a wireless transceiver.

43. The method of claim 33, where the service includes video encoding or decoding and the hardware is a digital signal processor (DSP).

44. A system comprising:
one or more processors;
memory coupled to the one or more processors and configured for storing instructions, which, when executed by the one or more processors, causes the one or more processors to perform operations comprising:
determining a probability that an application running on a device is likely to use a service supported by hardware in or coupled to the device, where the probability is determined from a predictive model based on application type;
comparing the probability with a threshold value; and
activating the hardware before the service is requested by the application based on results of the comparing.

45. The system of claim 44, where determining the probability further comprises:
determining that a primary function of the application is related to the service supported by the hardware.

46. The system of claim 44, where the prediction model is based at least in part on metadata provided by the application.

47. The system of claim 46, where the metadata includes entitlements or authorizations to access network resources or other operating system functions associated with the service.

48. The system of claim 46, where the metadata indicates software objects that are being used by the application.

49. The system of claim 44, where the device is a mobile device and the service is a location service.

50. The system of claim 44, further comprising:
presenting a dialog on a display of the device after starting the activating, the dialog providing an option for allowing or disallowing the application to access the service;
determining that access is allowed; and
allowing the application to access the service.

51. The system of claim 44, further comprising:
presenting a dialog on a display of the device after starting the activating, the dialog providing an option for allowing or disallowing the application to access the service;
determining that access is denied; and
deactivating the hardware.

52. The system of claim 44, further comprising:
presenting a dialog on a display of the device after starting the activating, the dialog providing an option for allowing or disallowing the application to access the service;
determining that the timer has expired without the option being exercised by a user of the device; and
deactivating the hardware.

53. The system of claim 44, where activating hardware includes starting the hardware or changing the power state of the hardware.

54. The system of claim 44, where the service is wireless services and the hardware is a wireless transceiver.

55. The system of claim 44, where the service includes video encoding or decoding and the hardware is a digital signal processor (DSP).

56. A system comprising:
one or more processors;
memory coupled to the one or more processors and configured for storing instructions, which, when executed by the one or more processors, causes the one or more processors to perform operations comprising:
determining a probability that an application running on a device is likely to use a service supported by hardware in or coupled to the device, where the probability is determined from a predictive model based on historical usage patterns associated with the application;
comparing the probability with a threshold value; and
activating the hardware before the service is requested by the application based on results of the comparing.

57. The system of claim 56, where determining the probability further comprises:
determining a number of times the application has been accessed in the past.

58. The system of claim 57, where determining a number of times the application has been accessed in the past includes incrementing or decrementing a count each time the application is accessed.

59. The system of claim 56, determining a number of times the application has been accessed in the past includes incrementing or decrementing a count each time a user grants access to the application.

60. The system of claim 56, where the device is a mobile device and the service is a location service.

61. The system of claim 56, further comprising:
presenting a dialog on a display of the device after starting the activating, the dialog providing an option for allowing or disallowing the application to access the service;
determining that access is allowed; and
allowing the application to access the service.

62. The system of claim 56, further comprising:
presenting a dialog on a display of the device after starting the activating, the dialog providing an option for allowing or disallowing the application to access the service;
determining that access is denied; and
deactivating the hardware.

63. The system of claim 56, further comprising:
presenting a dialog on a display of the device after starting the activating, the dialog providing an option for allowing or disallowing the application to access the service;
determining that the timer has expired without the option being exercised by a user of the device; and
deactivating the hardware.

64. The system of claim 56, where activating hardware includes starting the hardware or changing the power state of the hardware.

65. The system of claim 56, where the service is wireless services and the hardware is a wireless transceiver.

66. The system of claim 56, where the service includes video encoding or decoding and the hardware is a digital signal processor (DSP).
